(19) United States
(12) Patent Application Publication
(10) Pub. No.: US 2012/0052254 A1
(43) Pub. Date: Mar. 1, 2012

(54) INNER COVER SHEET AND A METHOD FOR FASTENING A SHEET BLOCK TO A BINDING COVER, AND A BINDING

(75) Inventor: Henri Huotari, Espoo (FI)

(73) Assignee: Maping Kommandiittiyhtio L. Huotari, Espoo (FI)

(21) Appl. No.: 13/145,919

(22) PCT Filed: Jan. 27, 2010
(86) PCT No.: PCT/IB2010/000360

§ 371 Date: Nov. 1, 2011

(30) Foreign Application Priority Data
Jan. 30, 2009 (EP) 09151829.0

(51) Int. Cl. B32B 3/00; B42C 11/00

(52) U.S. Cl. 428/189; 412/4

(57) ABSTRACT

A method for fastening a sheet block (32) to a binding cover (41, 51), implemented in such a way that i) a binding (30) is formed by fastening to at least one side of a sheet block (32), at least one inner cover sheet (10) according to any of the claims 1 to 5 at the location of the attenuation component (12) by fastening devices (33) such as staples, for example, penetrating through the inner cover sheet (10); and ii) fastening the binding (30) thus created to the binding cover (41, 51) by gluing the binding (30) to the inner side (61, 62) of the binding cover (41, 51) by using the adhesive surface or surfaces (11) of at least one inner cover sheet (10). Independent patent claims for an inner cover sheet and a binding.

### FIELD OF THE INVENTION

The invention relates to the fastening of a sheet block to a binding cover by using an inner cover sheet, and further relates to a binding comprising a sheet block and an inner cover sheet.

1. State of the Art

According to the known state of the art, sheets can be joined to each other by stapling. A stapled sheet block is covered by fastening it from the front and back sides by gluing to a separate cover, such as a hard cover. Thus one can easily make a neat and durable book.

An annoying problem, however, is the duplicating of the staple shapes on the surface of the cover. The staple's shape is duplicated on the cover when the cover is pressed against the staple. This most typically occurs when the book is pressed by the fingers in the area of the spine groove, which often occurs accidentally when books are handled. After the shape of a staple has once been duplicated on the cover, it is difficult if not impossible to restore it to its original shape. Such a book is often unfit for sale, and therefore it is permanently spoilt. Thus it can be said that a book made by stapling in this way is not of sufficiently high quality.

In order to avoid the staple shapes being duplicated, different kinds of reinforcements are indeed added to covers, typically 1 to 5 mm thick strips made of board. The manufacture of covers equipped with reinforcements is laborious and expensive, however, and in addition the reinforcements alter the appearance of the cover from what is familiar, in which case the product is not perceived as being of high quality.

2. Purpose of the Invention

The purpose of the invention is to enable the making of high-quality books by stapling simply and economically.

It is possible to achieve this purpose by an inner cover sheet and a method in accordance with independent patent claims.

A binding according to a parallel claim with the inner cover sheet is of high quality, simple and quick to make.

The dependent claims describe inventive aspects and those that are advantageous with respect to making the binding.

### Advantages of the Invention

An inner cover sheet according to the invention includes an inner cover leaf. On the reverse side of the inner cover leaf is at least one adhesive surface that includes adhesive suited for permanent gluing. On the edge of the inner cover sheet, fastened to the adhesive surface and/or arranged beside the adhesive surface, is at least one strip which includes at least one attenuation component.

In making a binding, the sheets of the sheet block should be fastened to each other at one edge (the binding edge), so that the binding actually stays together.

By using state-of-the-art cover sheets it has not been possible to make high-quality bindings by stapling, since the shape of the staples used for stapling is duplicated in the cover when the fingers press the ready binding through the binding cover on top of the staples.

An inner cover sheet according to the invention now enables the making of a high-quality binding by using stapling, because, due to the attenuation component, the shapes of the staples used in stapling are no longer duplicated when pressing with the fingers on the ready binding on top of the staples. Thus, the invention enables the quicker, and yet advantageous, making of a high-quality binding.

At its most simple, the attenuation component is implemented by fastening to the inner cover leaf a material accessory, preferably one that forms a cushion.

The adhesive surface of the inner cover sheet can be implemented at its most simple as a sticker on top of which there is a removable protective sheet.

By using an inner cover sheet according to the invention, it is possible to make a high-quality simple binding that is quick to manufacture. Such a binding then comprises a sheet block and one inner cover sheet according to the invention which is fastened to the sheet block at the location of the attenuation component by fixing devices such as staples, for example, penetrating through the inner cover sheet. The inner cover sheet is preferably on that side of the sheet block from which the fixing devices come out, but, in addition to this or alternatively, there may be an inner cover sheet according to the invention on the other side of the sheet block, too. It is most economical to arrange the fixing devices so that they also fasten the sheets of the sheet block to each other, for thus the sheets do not need to be glued to each other, for example.

If the binding also comprises a uniform binding cover which is, at least from one side, glued to the adhesive surface of the inner cover sheet of the binding in such a way that the inner cover leaf of the inner cover sheet acts thus as an inner cover, it is possible to form from the binding a high-quality book made by stapling, especially if the sheets comprise paper sheets. The high quality is emphasized in an especially ingenious way if the threshold area of the binding back of the binding cover is located on top of the attenuation component or extends from the binding back onto the attenuation component, since, in the threshold area, the staple or other mechanical fixing element used is duplicated most easily in pressing with the finger when using some other kind of inner cover sheet.

The method for fastening a sheet block to a binding cover comprises the following steps: Forming a binding by fastening, to at least one side of a sheet block, at least one inner cover sheet according to the invention at the location of an attenuation component by fastening devices such as staples, for example, penetrating through the inner cover sheet; after this, fastening the binding thus created to a binding cover by gluing the binding to the inner side of the binding cover by using the adhesive surface or surfaces of at least one inner cover sheet. The method enables the quicker, and yet economical, making of a high-quality binding. The inner cover sheet is preferably on that side of the sheet block from where the fastening devices come out, but there may be an inner cover sheet according to the invention in addition to or instead of this on the other side of the sheet block.

The making of a binding is considerably speeded up if, at the same work step as the inner cover sheets are fastened to the sheet block, the sheets of the sheet block are also fastened to each other.

The making of a binding by using the presented method is greatly eased if the protective sheets of the adhesive surfaces of the inner cover sheets are removed prior to fastening the binding to the binding cover, but only after the formation of the binding. Thus the adhesive surfaces can be glued in a more controlled way without them disturbing operations by, for example, sticking to the working table.

In practice, the removal of the protective sheets is easiest when they are removed one at a time, with the binding being turned upside down in between times.

### LIST OF DRAWINGS

The detailed description below describes, by way of example, the structure of a binding back and a binding according to the invention and a method according to the invention in more detail.

The accompanying drawings present:

FIG. 1 an inner cover sheet, with its adhesive surface and the attenuation component turned upwards;

FIG. 2 the other side of the inner cover sheet presented in FIG. 1, i.e. the inner cover leaf, turned upwards;

FIG. 3 the binding in which the inner cover sheet presented in FIGS. 1 and 2 is stapled fast to the sheet block;

FIGS. 4 and 5 a binding according to FIG. 3, which is glued to a binding cover;

FIG. 6 a schematic drawing of a binding cover;

FIG. 7 a cross-section of a binding according to FIG. 3 prior to stapling of the inner cover sheets to the sheet block;

FIG. 8 a cross-section of a binding according to FIG. 7 after stapling;

FIG. 9 a cross-section of a binding according to FIG. 5 in which a binding stapled fast to a sheet block according to FIG. 3 is glued to a binding cover;

FIG. 10 a cross-section of a binding cover according to FIG. 6; and

FIG. 11 a cross-section of a binding according to FIG. 4.

The same reference numbers refer in all drawings to the same or like structural parts.

### DETAILED DESCRIPTION OF THE INVENTION

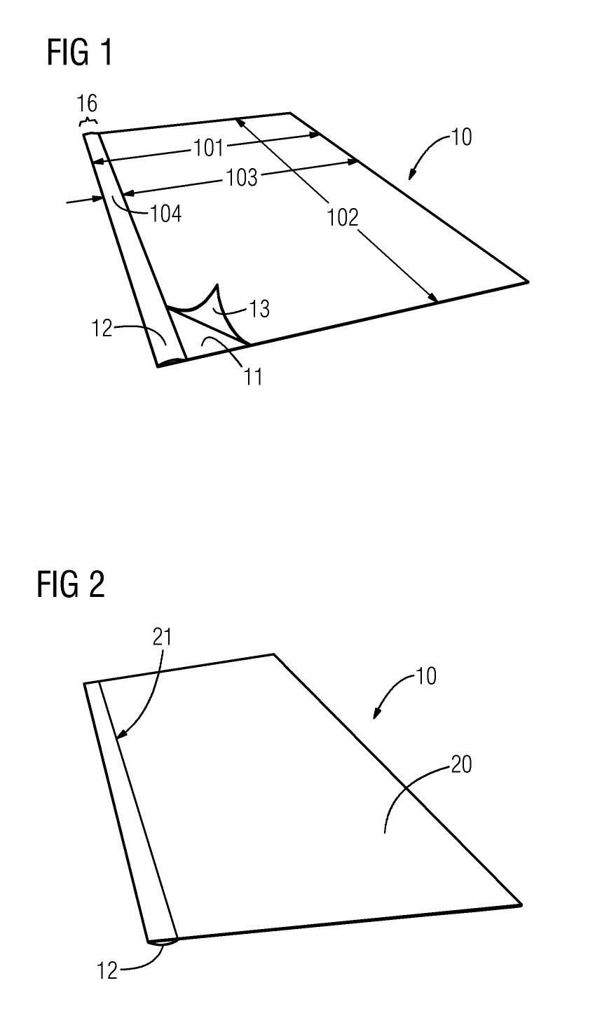

FIGS. 1 and 2 present an inner cover sheet 10 which is suitable for fastening a sheet block to a binding cover. The inner cover sheet 10 comprises an inner cover leaf 20 and, on the reverse side of the inner cover leaf 20, an adhesive surface 11 comprising an adhesive suitable for permanent gluing.

Along one edge of the inner cover sheet 10 on the side of the adhesive surface 11, fastened to the adhesive surface 11 and/or arranged beside the adhesive surface 11, is at least one strip 16 comprising at least one attenuation component 12.

A groove or crease 21 is made at the border of the strip 16 by a groove-making machine (“creasing machine”) so as to create a line for folding. The inner cover leaf of the finished book opens along the folding line, thus ensuring an end result that is neater and more even in quality.

The width 104 of the strip 16 is chosen so that, of the total width 101 of the inner cover sheet 10, the width 103 of the adhesive surface 11 is sufficient to fasten the inner cover sheet to the binding cover. At the same time, the width 104 of the strip 16 should, however, be sufficient to enable the inner cover sheet 10 to be fastened strongly enough to the sheet block by stapling.

The attenuation component 12 is implemented by fixing a material accessory to the inner cover leaf 10. The material accessory forms a cushion and the material accessory is softer material than the inner cover leaf 20 of the inner cover sheet 10.

The adhesive surface 11 is implemented as a sticker sheet on top of which there is a removable protective sheet 13.

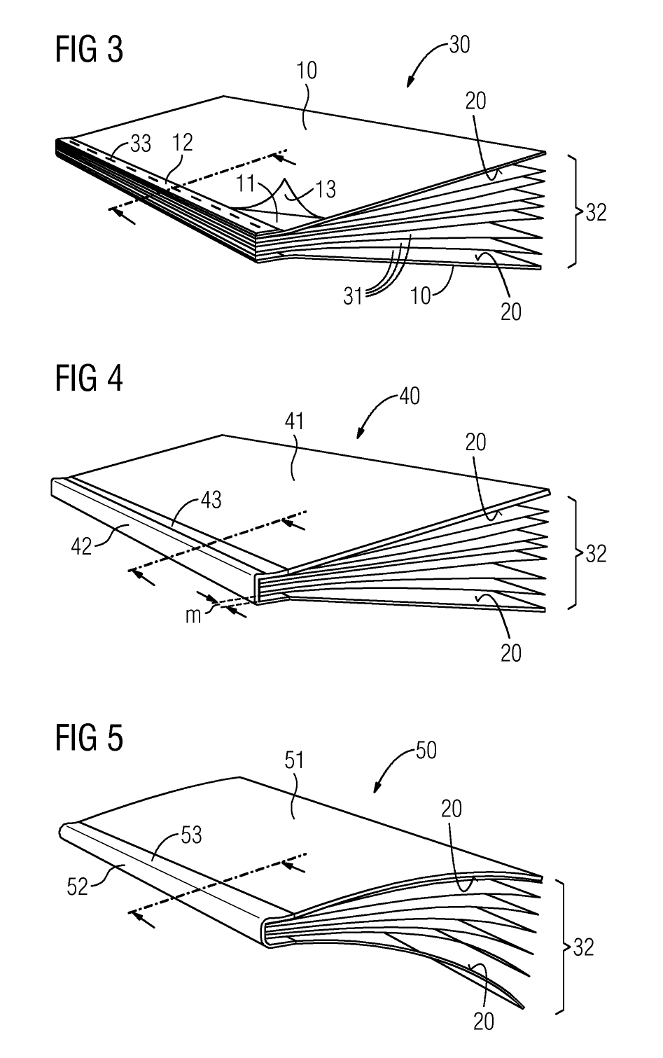

In FIG. 3, the inner cover sheet 10 is stapled fast to a sheet block 32, formed from individual sheets 31, at the location of the strip 16 by means of staples 33 penetrating through the inner cover sheets 10 at the location of the attenuation components 12.

The stapling event is illustrated in FIG. 7 and FIG. 8. The top inner cover sheet 10 is located on top of the sheet block 32, with the inner cover leaf 20 on the down side and the protective sheet 13 of the adhesive surface 11 on the up side. The bottom inner cover sheet 10 is located under the sheet block 32, with the inner cover leaf 20 on the up side and the protective sheet 13 of the adhesive surface 11 on the down side.

When the binding edge of the sheet block 32 is sufficiently precisely in a line 71, the top inner cover sheet 10, the sheet block 32 and the bottom inner cover sheet 10 can be fastened to each other by a staple 33. The staple 33 is placed beside the binding edge of the inner cover sheets 10 and the sheet block 32. For this reason, at least one attenuation component 12 at the edge of the inner cover sheet 10 is compressed under the influence of the staple 33. In order to illustrate this, the thickness d₁ of the attenuation component 12 in FIG. 7 is presented as bigger than the disclosure of the thickness d₂ of the attenuation component 12 drawn in FIG. 8 after stapling.

In other words, a binding 30 is formed by fastening to each side of the sheet block 32 at least one inner cover sheet 10 at the location of the attenuation component 12 by stapling through the inner cover sheets 10. The binding 30 to be created thus comprises the sheet block 32 and at least two inner cover sheets 10 according to any former claim, one on each side of the sheet block 32, and each of which is stapled to the sheet block 32 at the location of the attenuation components 12 through the inner cover sheet 10.

The binding 30 thus created is fastened to a binding cover 41, 51, in which case an end product resembling that presented in FIG. 4 or 5 is created, i.e. a book 40, 50. FIG. 4 presents a hard cover book 40, and FIG. 5 presents a soft cover book 50. The following paragraphs present first the utilisation of the inner cover sheet 10 according to the invention for a hard cover book 41.

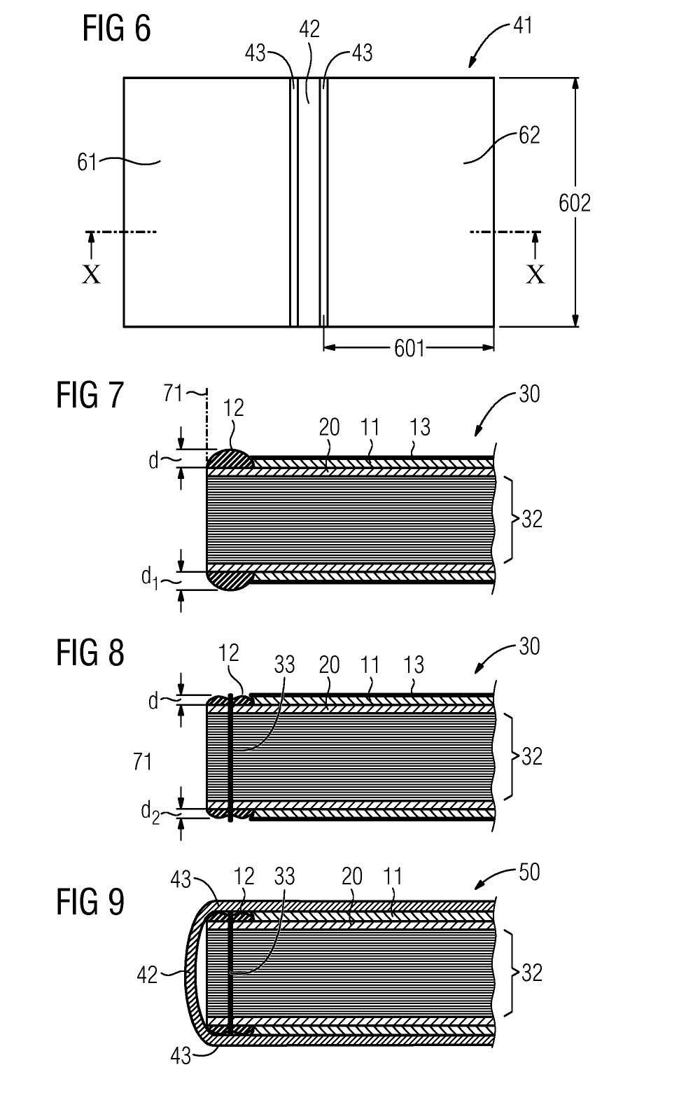

Fastening is implemented by gluing the binding 30 to inner sides 61, 62 of the binding cover 41 such as that presented in FIG. 6 by utilising the adhesive surface or surfaces 11 of the inner cover sheets 10.

The height 102 of the inner cover sheet 10 is chosen to correspond with the height 602 of the desired binding cover 41. The width 101 of the inner cover sheet 10 is chosen to correspond with the width 601 of the binding cover 41. An aesthetically better end result is created when the inner cover sheet 10 is the size of the sheet block 32 or slightly bigger. Furthermore, the sheet block 32 is preferably smaller on each side, by the size of the margin m (see FIG. 4), than the width 102 and the height 602 respectively of the binding cover 41, with the result that the binding cover 41 will remain visible at the edges under the sheet block 32. Typically, for a sheet block 32 of the DIN A4 size, for example, a margin m of size 2.5-7.5 mm will be left. In other words, the measurement 601 of the binding cover 41 is preferably bigger than that of the sheet block 32.

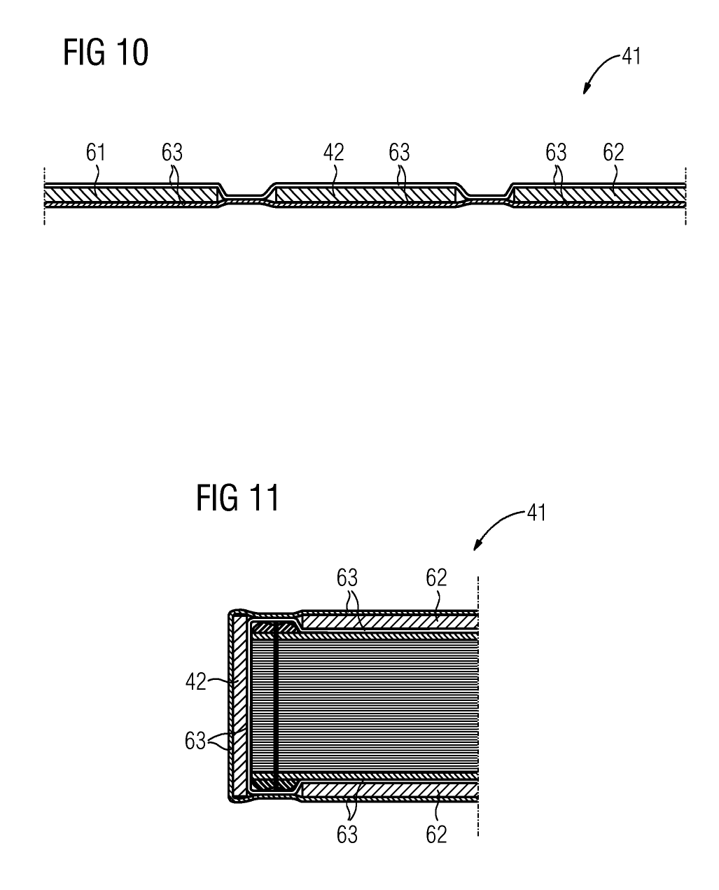

FIG. 10 is a cross-section X-X of the binding cover 41 presented in FIG. 6. The binding cover 41 is formed by placing a sheet of covering material 63 on a table and then by gluing the inner sides 61, 62 and a spine splinter 42 to the covering material 63. Between the spine splinter 42 and the inner sides 61, 62 is the threshold area 43. After this the material outside the corners of the inner sides 61, 62 is removed from the covering material 63, after which the part extending outside the inner sides 61, 62 of the covering material 63 is folded onto the edges of the inner sides 61, 62.

The binding cover 41 is thinner and more flexible in the threshold area 43. The threshold area 43 makes it easier to bend the binding cover 41. In addition, it makes the binding cover 41 more aesthetically pleasing. It is just this threshold area 43 that, due expressly to its thinness and flexibility, is particularly vulnerable to duplication of the bases of the staples 33.

A cross-section corresponding to a line IV-IV cut through a binding according to an advantageous embodiment of the invention, i.e. a hard cover book 40, is presented in FIG. 11. In that case, a binding 30 such as is presented in FIG. 8 is glued fast to the binding cover 41.

The protective sheets 13 of the adhesive surfaces 11 are removed prior to fastening the binding 30 to the binding cover 41, but only after the formation of the binding 30.

Gluing is easier when the protective sheets 13 are removed one at a time, between which the binding 30 is turned upside down. By gluing the adhesive surfaces 11 of the inner cover sheets 10 in the presented way to the binding backs 61, 62 of the binding cover 41 on each side of the spine splinter 42, the inner cover leafs 20 of the inner cover sheets 10 thus act as the inner cover of the book 40.

Because the staple 33 compresses the attenuation component 12, the base of the staple 33 sinks into the attenuation component to such an extent that the staple shapes are not duplicated through the binding cover 41 when the staple cover is pressed at the location of the staple, in which case the binding, i.e. the hard cover book 40, will be high-quality.

The utilisation of the inner cover sheet 10 is especially advantageous if the threshold area 43 of the binding backs 42 of the binding cover 41 is located on top of the attenuation component 12 or extends from the binding backs 42 onto the attenuation component 12. As was explained above, the binding cover 41 is thinner and more flexible in the threshold area 43. Because the sheet block 32 is bound from the binding edge, and because the threshold area 43 is also located at the binding edge, the possibility is thus offered to a critical user to quickly identify whether the binding is of high quality or not. If the inner cover sheet 10 is not used, but the book 40 is made by stapling, it is especially the threshold area 43 that is problematic in this sense.

The advantage achievable by stapling is that, at the same work step, it is possible both to fasten the inner cover sheets 10 to the sheet block 32 and to fasten the sheets 31 of the sheet block 32 to each other. In principle, however, it is possible to use some other corresponding fastening method that compresses the attenuation component 12.

It is correspondingly possible to use the inner cover sheet 10 according to the invention also for a soft cover book 50 (see FIG. 5) in the way presented in FIG. 9. In this case, with respect to the kind of binding presented in FIG. 8, the protective sheet 13 is removed from the adhesive surface 11 of the inner cover sheets 10, after which the adhesive surface 11 is fastened to the binding cover 51. The soft binding cover 51 has no spine splinter, but the cover 51 is soft. For this reason, the threshold area 53 is soft over a longer distance.

For all the embodiments of the invention, an especially good solution is to clinch the ends of the staples 33 in the same direction as the adhesive surface 11 and firmly against the attenuation component 12. In that case the attenuation component 12 can be thin, in which case the production costs will be smaller. In that case cellular plastic, which, in terms of its thickness, is only slightly thicker than the strength of the staple 33, will act as a very good cushion. For example, cellular plastic that is only 0.7 mm thick will be suitable as an attenuation component for the staple 33 of strength 0.5 mm.

Alternatively, the ends of the staples 33 can be bent in a curve towards each other. This is not such an advantageous solution, because the cushioning material will then be thicker at least on the side where the staple 33 comes out.

To those skilled in the art it is clear that the detailed description of the invention or the form of words chosen for the claims is not meant to restrict the protective scope demanded for the invention. The invention can also be implemented in ways deviating from the embodiment described in the detailed description, while still remaining within the framework of the protective scope of the claims.

1. An inner cover sheet (10) for fastening a sheet block (32) to a binding cover (40, 50), characterised in that:
the inner cover sheet (10) comprises an inner cover leaf (20);
the reverse side of the inner cover leaf (20) has at least one adhesive surface (11) which includes adhesive suitable for permanent gluing; and
on the edge of the inner cover sheet (10) fastened to the adhesive surface (11) and/or arranged beside the adhesive surface (11) is at least one strip (16) which includes at least one attenuation component (12).

2. The inner cover sheet (10) of claim 1, wherein the attenuation component (12) is implemented by fastening a material accessory to the inner cover leaf (10).

3. The inner cover sheet (10) of claim 2, wherein the material accessory forms a cushion.

4. The inner cover sheet (10) of claim 1, wherein the adhesive surface (11) is implemented as a sticker, on top of which there is a removable protective sheet (13).

5. The inner cover sheet (10) of claim 1, further comprising a groove or crease (21) between the strip (16) and the adhesive surface (11) and/or between the attenuation component (12) and the adhesive surface (11) which forms a line for folding.

6. A binding (30, 40, 50) comprising a sheet block (32) and at least one inner cover sheet (10) according to claim 1, which is fastened to the sheet block (32) at the location of the attenuation components (12) by fixing devices (33) such as staples, for example, penetrating through the inner cover sheet (10), and which is located on one side of the sheet block (32), preferably on that side from which the fixing devices (33) come out; in addition to or instead of this inner cover sheet (10), on that side of the sheet block (32) from which the fixing devices (33) go in can be at least one inner cover sheet (10).

7. The binding (30, 40, 50) of claim 6, wherein the fixing devices (33) have been arranged to also fasten the sheets (31) of the sheet block (32) to each other.

8. The binding (30, 40, 50) of claim 6, further comprising a uniform binding cover (41, 51), which is, on one side of the binding (30), glued to the adhesive surface (11) of at least one inner cover sheet (10) of the binding (30), in such a way that the inner cover leaf (20) of the inner cover sheet (10) acts thus as an inner cover.

9. The binding (30, 40, 50) of claim 8, wherein the threshold area (43, 53) of the binding back (42, 52) of the binding cover (41, 51) is located on top of the attenuation component (12) or extends from the binding back (42, 52) onto the attenuation component (12).

10. The binding (30, 40, 50) of claim 6, wherein the sheets (31) of the sheet block (32) comprise paper sheets.

11. The binding (30, 40, 50) of claim 6, wherein the fixing devices (33) are staples.

12. A method for fastening a sheet block (32) to a binding cover (41, 51) comprising the following acts:
forming a binding (30) by fastening, to at least one side of a sheet block (32), at least one inner cover sheet (10) according to claim 1, at the location of an attenuation component (12) by fastening devices (33) such as staples, for example, penetrating through the inner cover sheet (10); and
fastening the binding (30) thus created to a binding cover (41, 51) by gluing the binding (30) to the inner side (61, 62) of the binding cover (41, 51) by using the adhesive surface or surfaces (11) of at least one inner cover sheet (10).

13. The method of claim 12, wherein fastening the inner cover sheets (10) to the sheet block (32) comprises fastening, at the same work step, the inner cover sheets (10) to the sheet block (32) and the sheets (31) of the sheet block (32) to each other.

14. The method of claim 12 wherein, prior to fastening the binding (30) to the binding cover (41, 51) (41,51), but only after the formation of the binding (30), the protective sheets(13) of the adhesive surfaces (11) of the inner cover sheets (10) are removed.

15. The method of claim 14 wherein the protective sheets (13) are removed one at a time, with the binding (30) being turned upside down in between times.
